(19) United States
(12) Patent Application Publication
(10) Pub. No.: US 2026/0243585 A1
(43) Pub. Date: Aug. 20, 2026

(54) MECHANICALLY BALANCED ONE POLE PAIR INDUCTIVE POSITION SENSOR

(71) Applicant: HL MANDO CORPORATION, Gyeonggi-do (KR)

(72) Inventors: Md Sariful ISLAM, Auburn, MI (US); Mohammad ISLAM, Auburn, MI (US)

(21) Appl. No.: 19/310,369

(22) Filed: Aug. 26, 2025

Related U.S. Application Data
(60) Provisional application No. 63/760,084, filed on Feb. 18, 2025.

(51) Int. Cl. G01D 5/20; B60T 1/06; B60T 13/74; B60T 17/22; F16D 55/226; F16D 66/00; F16D 121/24

(52) U.S. Cl. CPC G01D 5/20; B60T 1/065; B60T 13/746; B60T 17/22; F16D 55/226; F16D 66/00; F16D 2066/003; F16D 2066/006; F16D 2121/24

(57) ABSTRACT

An electromechanical brake (EMB) system is provided. The EMB system includes: a brake rotor configured to be rotatable with a wheel of a vehicle; a brake pad assembly configured to be engageable with the brake rotor; an actuator assembly having an electric motor configured to mechanically move the brake pad assembly toward or away from the brake rotor; and an inductive position sensor configured to sense a position of the electric motor. The inductive position sensor being a one pole pair inductive position sensor that includes: a metallic target having a main lobe and a balancing lobe; and a sensor portion configured to determine a position of the metallic target.

### CROSS REFERENCE TO RELATED APPLICATION

This application claims the benefit from and the priority to U.S. Patent Application Ser. No. 63/760,084, filed on Feb. 18, 2025, titled “MECHANICALLY BALANCED ONE POLE-PAIR INDUCTIVE POSITION SENSOR”, which is hereby incorporated herein by reference in its entirety.

### BACKGROUND

Various embodiments of the present disclosure generally relate to an electromechanical brake (EMB) system (also referred to herein as an “EMB assembly”) and more particularly to an inductive position sensor of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Electric brake systems may also include an electric motor that controls movement of the electric actuator and sensors for measuring a position of the electric motor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor; and an inductive position sensor configured to sense a position of the electric motor. The inductive position sensor may be a one pole pair inductive position sensor that comprises: a metallic target comprising a main lobe and a balancing lobe; and a sensor portion configured to determine a position of the metallic target.

The balancing lobe comprises a partial ring shape and is connected to the main lobe via connection portions that protrude outward of a body of the main lobe, and wherein a total circumference of the metallic target comprising a circumference of the main lobe and a circumference of the balancing lobe is 360 degrees.

The main lobe, the balancing lobe, and the connection portions that connect the main lobe with the balancing lobe are formed as a monolithic structure.

A first mass times inertia value of a first side of the metallic target comprising the main lobe is equal to a second mass times inertia value of a second side of the metallic target comprising the balancing lobe.

The metallic target comprises a central axis that separates the main lobe and the balancing lobe, and the balancing lobe comprises a cutout portion having an inner radius of the partial ring shape of the balancing lobe.

A distance from the central axis to the inner radius of the balancing lobe is larger than a distance from the central axis to an outer radius of the main lobe.

A size and mass of each of the connection portions are dependent on a size and mass of the balancing lobe, a size and mass of the main lobe, and a maximum speed at which the metallic target is configured to be rotated within the inductive position sensor.

Only a position of the main lobe is configured to be sensed by the sensor portion for determining the position of the metallic target.

The balancing lobe is configured to mechanically balance the metallic target as the metallic target rotates within the inductive position sensor.

The sensor portion comprises transmitter coils configured to generate eddy current within the metallic target and receiver coils configured to sense the position of the metallic target, and wherein a position of the receiver coils on the sensor portion overlaps with only the main lobe of the metallic target.

According to various embodiments of the present disclosure, an inductive position sensor may comprise: a metallic target comprising a main lobe and a balancing lobe; and a sensor portion configured to determine a position of the metallic target. The inductive position sensor is a one pole pair inductive position sensor, and the inductive position sensor is configured to sense a position of an electric motor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2A shows a radial view of an inductive position sensor according to one or more exemplary embodiments of the present disclosure.

FIG. 2B shows an axial view of an inductive position sensor according to one or more exemplary embodiments of the present disclosure.

FIG. 2C shows a metal target of the inductive position sensor of FIGS. 2A and 2B according to one or more exemplary embodiments of the present disclosure.

FIGS. 3A and 3B show test results graphs according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

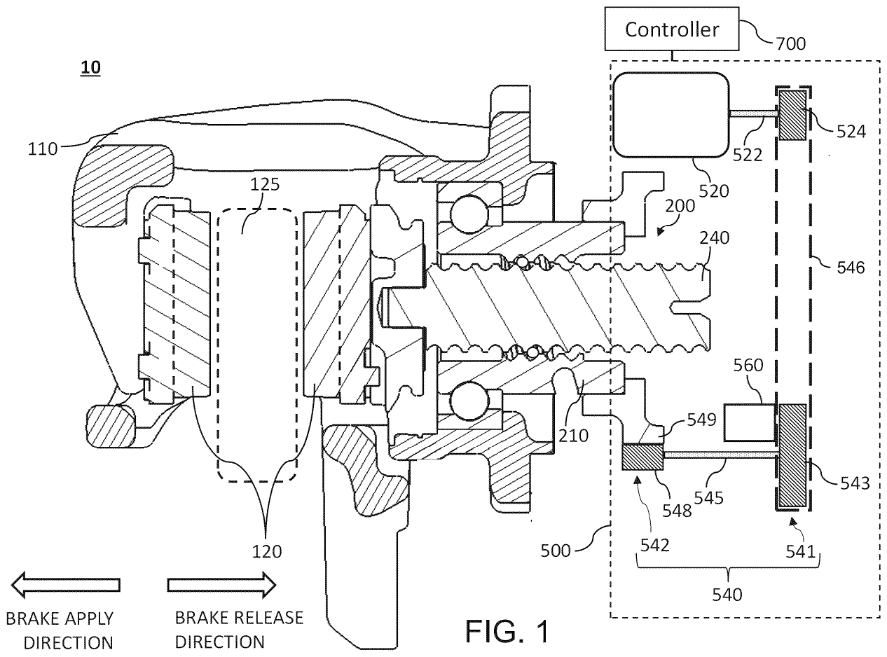

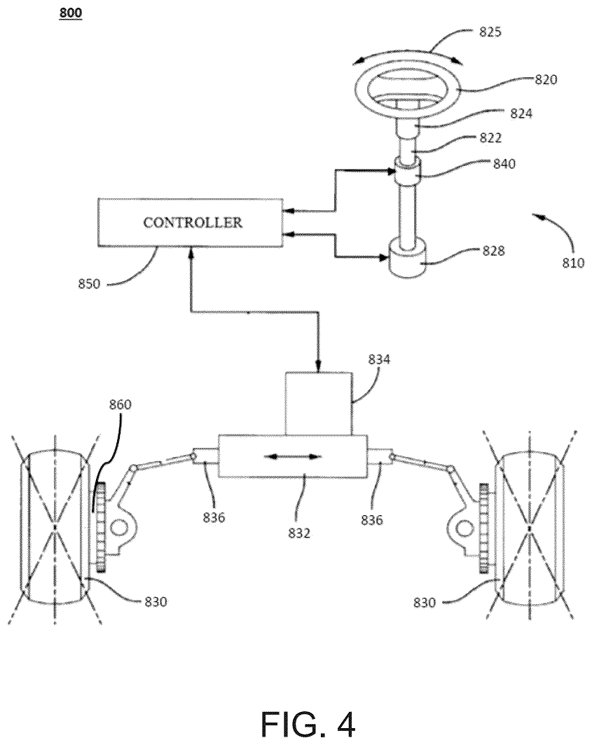

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Such brake systems are usually equipped with an inductive position sensor for acquiring (e.g., sensing) a geometrical position and orientation of an electric motor shaft (e.g., of electric motor 520 discussed below in reference to FIG. 1) in order for the brake system to drive (e.g., control) the electric motor with the best efficiency and robustness. Due to their compatibility with all types of motors (e.g., motors having any number of motor poles), one pole pair inductive sensors have become a popular choice for brake systems. However, the single lobe of the metallic target in one pole pair inductive sensors is mechanically unbalanced and asymmetric, which creates a high risk of mechanical failure for brake systems used for high performance (e.g., high motor speed) applications. Thus, there has been a long felt need in the technical fields of sensor and brake system technologies for a one pole pair inductive sensor design that is less prone to mechanical failure when used in high performance applications.

Exemplary embodiments inductive position sensors described herein may be used in a steering system such as a steer-by-wire type steering system to detect one or more positions of a steering wheel, a steering shaft, a rotor, a gear, a pulley, a ball nut, and/or a motor.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

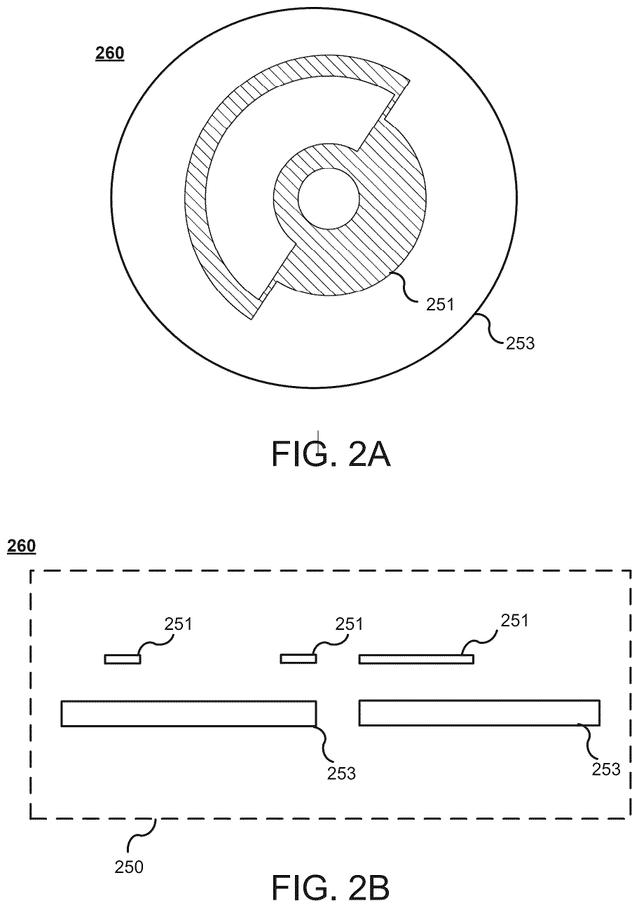

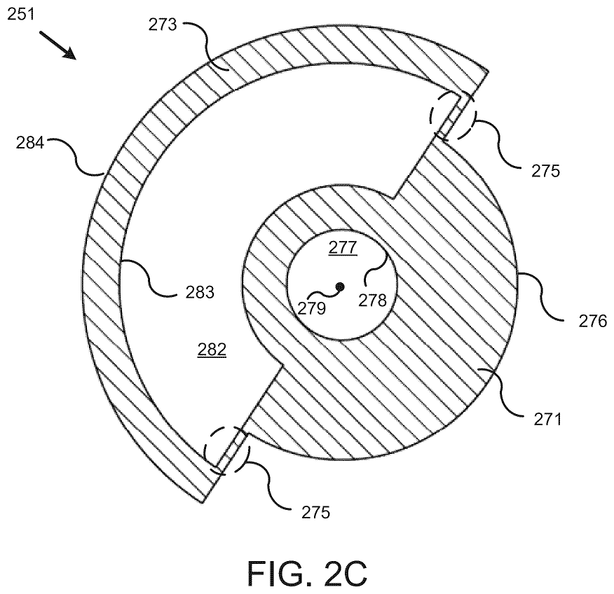

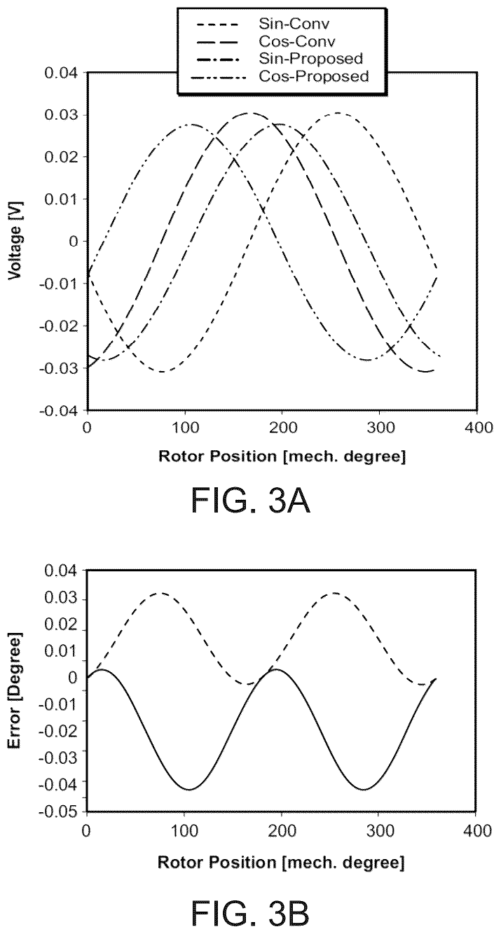

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125). One example of the sensors configured to be installed within the brake assembly 10 may be the inductive position sensor of embodiments disclosed herein that is described in more detail in reference to FIGS. 2A-3B.

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

FIG. 2A shows a radial view of an inductive position sensor 260 in accordance with one or more exemplary embodiments of the present disclosure while FIG. 2B shows an axial view of the same inductive position sensor 260.

As shown in FIGS. 2A and 2B, the inductive position sensor 260 may include, within a position sensor housing 250 or the like, a target 251 that is placed on top of a sensing portion 253 (also referred to herein as a “sensor portion”). The target 251 may be a metallic target made out of, for example, but not limited to: copper (CU), aluminum (AL), or stainless steel (SS). The sensing portion 253 may be configured as a printed circuit board (PCB) that includes sensing circuitry.

The sensing circuitry on the PCB configured the sensing portion 253 may include sensing coils (not shown). The sensing coils may include one or more transmitter coils and one or more receiver coils. The transmitter and receiver coils may be formed as conductive (e.g., copper, gold, or the like) traces on the layers (e.g., upper, lower, and/or intermediate layers) of the PCB. The sensing coils may also be connected to a position sensor controller (e.g., microcontroller chip or the like) (not shown) for providing signals (e.g., using an oscillator circuit or the like) to one or more of the sensing coils and for converting signals generated by the sensing coils into a sensor output (e.g., the position of electric motor 520).

For example, the position sensor controller (e.g., using the oscillator circuit) may provide a high frequency alternating current (AC) signal through the transmitter coils, creating an alternating magnetic field around the transmitter coils and the target 251. The magnetic field induces eddy currents in the target 251, which generates their own (e.g., the eddy current's own) magnetic field that opposes the magnetic field generated by the transmitter coils causing the target 251 to rotate above the sensing portion 253. This change in the magnetic field affects the inductance and/or amplitude of the signal in transmitter coils. This change in the magnetic field is sensed by the receiver coils and converted (e.g., using the position sensor controller) into a signal proportional to the distance or position of the target 251 (e.g., the position of one or more lobes of the target 251).

In embodiments, the transmitter coils may be disposed (e.g., on the PCB forming sensing portion 253) radially outside of an outer radius of the target 251 while the receiver coils may be disposed radially inside of an outer radius of the target 251. Alternatively, the transmitter coils may also be disposed radially inside of the outer radius of the target 251. Other configurations regarding the placement of the transmitter and receiver coils on the sensing portion with respect to the outer radius of the target 251 may also be used without departing from the scope of embodiments disclosed herein.

As shown in FIG. 2C, which shows an example target 251 of embodiments disclosed herein, the target 251 may be configured as a one pole pair position sensor target having only a single lobe to be sensed by the sensing portion 253.

In particular, target 251 of FIG. 2C includes a main lobe 271 for sensing by the sensing portion 253, a balancing lobe 273 configured for mechanically balancing the target 251 that will not be sensed by the sensing portion 253, and connection portions 275 that protrude outward from a body of the main lobe to connect the main lobe 271 with the balancing lobe 273.

The target 251 may also have a cutout 277 having a central axis 279 of the target 251. The cutout 277 may define an inner radius 278 (ML_{IR}) of the main lobe 271. The main lobe may also have an outer radius 276 (ML_{OR}).

In embodiments, the distance from the central axis 279 to both the ML_{IR} 278 and the ML_{OR} 276 may be predetermined by a manufacturer of the inductive position sensor (and/or the brake assembly) based on factors such as, but not limited to: (i) the size of the electric motor 520; (ii) the performance rating of the electric motor 520; (iii) the size of the inductive position sensor 260; (iv) the required performance of the inductive position sensor 260; and/or other factors associated with the ratings of the brake system 10 and/or the vehicle in which the brake system 10 is installed.

In embodiments, the mass of the main lobe 271 may be determined (e.g., calculated) using the equation of:

$${mass}_{main lobe} = \frac{π ( {ML}_{OR}^{2} - {ML}_{IR}^{2} )}{2} ρ$$

where ρ is the density of the material making up the target 251.

Other equations may also be used to calculate (e.g., determine) the mass of the main lobe 271 (e.g., based on different manufacturing and/or performance needs of the inductive position sensor 260, the brake assembly 10, and/or the vehicle) without departing from the scope of embodiments disclosed herein.

The balancing lobe 273 may also have a cutout portion 282 formed within a body of the balancing lobe 273. The cutout portion 282 may contain an inner radius 283 (BL_{IR}) of the balancing lobe 273 that is opposed to an outer radius 284 (BL_{OR}) of the balancing lobe 273.

In embodiments, a distance from the central axis 279 to BL_{IR} 283 of the balancing lobe 273 may be calculated using the equation of:

$$B {L}_{IR} = M {L}_{O R} + x$$

where x is the isolation between the main lobe 271 and the balancing lobe 273 (e.g., a radial length of the balancing lobe 273).

In embodiments, a distance from the central axis 279 to BL_{OR} 284 of the balancing lobe 273 may be calculated using the equation of:

$$B {L}_{O R} = \sqrt{M {L}_{O R}^{2} - M {L}_{IR}^{2} + B {L}_{IR}^{2}}$$

Although specific equations are presented above to determine (e.g., calculate) the distance from the central axis 279 to BL_{OR} 284 and BL_{IR} 283 of the balancing lobe 273, embodiments disclosed herein are not limited to these equations and other equations that are able to produce a mechanically balanced and symmetrical single lobe target 251 may also be used without departing from the scope of embodiments disclosed herein.

In embodiments, the balancing lobe 273 may be configured to have a ring shape (namely, a partial ring shape) with BL_{OR} 284 and BL_{IR} 283. The mass and size of the balancing lobe 273 may be dependent on the mass and size of the main lobe 271. For example, the mass times inertia (i.e., mass×inertia (I)) value of the main lobe 271 side of the target 251 should be equal to the mass times inertia value of the balancing lobe 273 side of the target 251. Thus, the size of the cutout portion 282 of the balancing lobe 273 may be determined (e.g., calculated) based on the required mass and size of the balancing lobe 273 ring in addition to using BL_{OR} 284 and BL_{IR} 283. Further, the balancing (e.g., by the balancing lobe 273) may be provided such that the center of gravity is at the rotating center of the target 251, either through mass balance or mass times inertia balance of the target 251.

Essentially, the two sides of the target 251 (i.e., the side having main lobe 271 and the side having balancing lobe 273) should be mechanically balanced and symmetrical such that the target 251 is mechanically balanced and has little to no risk of becoming unbalanced (e.g., fluctuating, tipping over towards one side, or the like) when the target 251 is rotated at a high speed (e.g., 5000 rpm or higher, or the like) within the housing 250 of the inductive position sensor 260. Additionally, the mass and size of the balancing lobe 273 should be configured such that only the main lobe 271 will be sensed by the sensing portion 253 of the inductive position sensor 260, thus effectively maintaining a single pole pair target configuration (e.g., a one pole pair inductive position sensor configuration). For example, a position of the receiver coils on the sensing portion 253 may only overlap with the main lobe 271 of the target 251 such that the receiver coils do not pick up any signals from the balancing lobe 273.

Additionally, in embodiments, BL_{IR} 283 should be larger than ML_{OR} 276 (i.e., BL_{IR} 283>ML_{OR} 276). Furthermore, a sum of a circumference of the main lobe 271 and a circumference of the balancing lobe 273 should equal 360 degrees. The ratio of the circumference the main lobe 271 and the circumference of the balancing lobe 273 may not need to be 50:50 (e.g., could be 60:40 or 40:60, or the like), and the circumference of the balancing lobe 273 will be dependent on the circumference of the main lobe 271. For example, if the main lobe 271 is configured with a circumference of 160 degrees, the balancing lobe 273 will have a circumference of 200 degrees.

In embodiments, the size and mass of each of the connection portions 275 may be determined based on the size and mass of the main lobe 271 and the balancing lobe 273. More specifically, the size and mass of each of the connection portions 275 may be determined as values that are able to create a mechanically balanced and symmetrical target 251 as the target 251 is rotating within the inductive position sensor housing 250. Said another way, the size and mass of each of the connection portions 275 may be identical and is set based on a size and mass required to mechanically balance the target 251 having the main lobe 271 and the balancing lobe 273 at a maximum speed at which the target 251 will be required to be rotated within the inductive position sensor housing 250.

In embodiments, only the main lobe 271 will be sensed by the sensing portion 253 of the inductive position sensor 260 for determining a motor position of the electric motor 520. Thus, the target 251 of embodiments disclosed herein, although fitted with balancing lobe 273, still retains the configuration of a single pole pair target (e.g., for a one pole pair inductive position sensor configuration). Because a one pole pair inductive position sensor configuration is retained using the target 251 of embodiments disclosed herein, the inductive position sensor 260 of embodiments disclosed herein may advantageously be compatible with any type of electric motors (e.g., electric motors having any number of motor pole pairs) while also providing the improvements of being mechanically balanced during rotation of the target 251, which further advantageously reduces (and/or even completely prevents) occurrence of mechanical failure of the inductive position sensor as a results of target instability and imbalance during rotation of the target.

In embodiments, the main lobe 271, the balancing lobe 273, and the connection portions 275 may be formed as a monolithic structure.

FIGS. 3A and 3B show performance results and comparisons between the target 251 of embodiments disclosed herein and a conventional single lobe target used in conventional one pole pair inductive position sensors.

In particular, FIG. 3A shows a graph of the rotor position sensed using the target 251 of embodiments disclosed herein and the conventional single lobe target. Particular, the sine and cosine signals received by the position sensor controller of the sensing portion 253 of the respective inductive position sensors (e.g., the conventional inductive position sensor and the inductive position sensor 260 of embodiments disclosed herein) are shown.

These rotor position measurements shown in FIG. 3A are then used to determine an measurement error rate in the rotor position by the respective inductive position sensors, as shown in the graph presented in FIG. 3B.

As shown in FIG. 3B, the error rate in the motor position (e.g., the absolute motor angle of electric motor 520, or the like) shown in FIG. 3B of the two inductive position sensors (e.g., the conventional inductive position sensor and the inductive position sensor 260 of embodiments disclosed herein) are pretty much identical within a range of +0.2-0.4 degrees, which illustrates that the target 251 of embodiments disclosed herein advantageously provides the mechanical balance lacking in conventional one pole pair targets while also retaining the same performance level as the conventional one pole pair targets.

Thus, the inductive position sensor 260 of embodiments disclosed herein having the target 251 that is configured with the main lobe 271 and balancing lobe 273 combination resolves the long felt need in the technical fields of sensor and brake system technologies for a one pole pair inductive sensor design that is less prone to mechanical failure when used in high performance applications.

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor which is connected to the steering shaft or steering column 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) system comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor; and
an inductive position sensor configured to sense a position of the electric motor, the inductive position sensor being a one pole pair inductive position sensor comprising:
a metallic target comprising a main lobe and a balancing lobe; and
a sensor portion configured to determine a position of the metallic target.

2. The EMB system of claim 1, wherein the balancing lobe comprises a partial ring shape and is connected to the main lobe via connection portions that protrude outward of a body of the main lobe, and wherein a total circumference of the metallic target comprising a circumference of the main lobe and a circumference of the balancing lobe is 360 degrees.

3. The EMB system of claim 2, wherein the main lobe, the balancing lobe, and the connection portions that connect the main lobe with the balancing lobe are formed as a monolithic structure.

4. The EMB system of claim 3, wherein a first mass times inertia value of a first side of the metallic target comprising the main lobe is equal to a second mass times inertia value of a second side of the metallic target comprising the balancing lobe.

5. The EMB system of claim 2, wherein the metallic target comprises a central axis that separates the main lobe and the balancing lobe, and the balancing lobe comprises a cutout portion having an inner radius of the partial ring shape of the balancing lobe.

6. The EMB system of claim 5, wherein a distance from the central axis to the inner radius of the balancing lobe is larger than a distance from the central axis to an outer radius of the main lobe.

7. The EMB system of claim 5, wherein a size and mass of each of the connection portions are dependent on a size and mass of the balancing lobe, a size and mass of the main lobe, and a maximum speed at which the metallic target is configured to be rotated within the inductive position sensor.

8. The EMB system of claim 1, wherein only a position of the main lobe is configured to be sensed by the sensor portion for determining the position of the metallic target.

9. The EMB system of claim 2, wherein the balancing lobe is configured to mechanically balance the metallic target as the metallic target rotates within the inductive position sensor.

10. The EMB system of claim 9, wherein the sensor portion comprises transmitter coils configured to generate eddy current within the metallic target and receiver coils configured to sense the position of the metallic target, and wherein a position of the receiver coils on the sensor portion overlaps with only the main lobe of the metallic target.

11. An inductive position sensor comprising:
a metallic target comprising a main lobe and a balancing lobe; and
a sensor portion configured to determine a position of the metallic target,
wherein the inductive position sensor is a one pole pair inductive position sensor, and
wherein the inductive position sensor is configured to sense a position of an electric motor.

12. The inductive position sensor of claim 11, wherein the balancing lobe comprises a partial ring shape and is connected to the main lobe via connection portions that protrude outward of a body of the main lobe, and wherein a total circumference of the metallic target comprising a circumference of the main lobe and a circumference of the balancing lobe is 360 degrees.

13. The inductive position sensor of claim 12, wherein the main lobe, the balancing lobe, and the connection portions that connect the main lobe with the balancing lobe are formed as a monolithic structure.

14. The inductive position sensor of claim 13, wherein a first mass times inertia value of a first side of the metallic target comprising the main lobe is equal to a second mass times inertia value of a second side of the metallic target comprising the balancing lobe.

15. The inductive position sensor of claim 12, wherein the metallic target comprises a central axis that separates the main lobe and the balancing lobe, and the balancing lobe comprises a cutout portion having an inner radius of the partial ring shape of the balancing lobe.

16. The inductive position sensor of claim 15, wherein a distance from the central axis to the inner radius of the balancing lobe is larger than a distance from the central axis to an outer radius of the main lobe.

17. The inductive position sensor of claim 15, wherein a size and mass of each of the connection portions are dependent on a size and mass of the balancing lobe, a size and mass of the main lobe, and a maximum speed at which the metallic target is configured to be rotated within the inductive position sensor.

18. The inductive position sensor of claim 11, wherein only a position of the main lobe is configured to be sensed by the sensor portion for determining the position of the metallic target.

19. The inductive position sensor of claim 12, wherein the balancing lobe is configured to mechanically balance the metallic target as the metallic target rotates within the inductive position sensor.

20. The inductive position sensor of claim 19, wherein the sensor portion comprises transmitter coils configured to generate eddy current within the metallic target and receiver coils configured to sense the position of the metallic target, and wherein a position of the receiver coils on the sensor portion overlaps with only the main lobe of the metallic target.
